(19) United States
(12) Patent Application Publication
(10) Pub. No.: US 2025/0265517 A1
(43) Pub. Date: Aug. 21, 2025

(54) INFORMATION PROCESSING METHOD, INFORMATION PROCESSING DEVICE, AND INFORMATION PROCESSING SYSTEM

(71) Applicant: Panasonic Intellectual Property Management Co., Ltd., Osaka (JP)

(72) Inventors: Kotaro SAKATA, Osaka (JP); Tetsuji FUCHIKAMI, Osaka (JP)

(21) Appl. No.: 19/200,859

(22) Filed: May 7, 2025

Related U.S. Application Data
(63) Continuation of application No. PCT/JP2023/036088, filed on Oct. 3, 2023.

(30) Foreign Application Priority Data
Nov. 24, 2022 (JP) 2022-187754

(51) Int. Cl. G06Q 10/0631; G06Q 10/10

(52) U.S. Cl. CPC G06Q 10/063112; G06Q 10/103

(57) ABSTRACT

An information processing method includes: obtaining first profile information and second profile information; obtaining first work plan information and second work plan information; deriving a first organizational distance in accordance with the first profile information and the second profile information; deriving a first work relevance in accordance with the first work plan information and the second work plan information; generating first information-to-be-presented in accordance with the first organizational distance and the first work relevance, where the first information-to-be-presented is information to be presented to a first worker as the profile of a second worker; and outputting the first information-to-be-presented.

### CROSS REFERENCE TO RELATED APPLICATIONS

This is a continuation application of PCT International Application No. PCT/JP2023/036088 filed on Oct. 3, 2023, designating the United States of America, which is based on and claims priority of Japanese Patent Application No. 2022-187754 filed on Nov. 24, 2022. The entire disclosures of the above-identified applications, including the specifications, drawings and claims are incorporated herein by reference in their entirety.

### FIELD

The present disclosure relates to an information processing device, an information processing method, and so on.

### BACKGROUND

Patent Literature (PTL) 1 proposes a worker assistance device for enabling a worker with limited knowledge of assigned work to work as well as a person familiar with the work. Specifically, PTL 1 discloses recognizing the situation of an object, performing appropriate information processing to construct visual information to be presented to the worker, and providing the visual information to the worker.

PTL 2 proposes an information presentation method that enables users to readily share useful information. Specifically, PTL 2 discloses calculating relevance based on behavior information, and performing, according to the relevance, steps from the request for the behavior information to its presentation.

### CITATION LIST

### Patent Literature

PTL 1: Japanese Unexamined Patent Application Publication No. 2009-69954
PTL 2: Japanese Unexamined Patent Application Publication No. 2017-162245

### SUMMARY

### Technical Problem

In a construction site, for example, work proceeds while various workers who do not know each other come and go according to their work plans. In such an environment with workers working together, it is not easy to efficiently communicate worker information among the workers while protecting their privacy.

In view of the above, the present disclosure provides an information processing method and the like that enable efficiently communicating information on workers while protecting their privacy.

### Solution to Problem

An information processing method according to one aspect of the present disclosure is to be performed by an information processing device and includes: obtaining first profile information indicating the profile of a first worker and second profile information indicating the profile of a second worker; obtaining first work plan information indicating the work plan of the first worker and second work plan information indicating the work plan of the second worker; deriving the first organizational distance between the first worker and the second worker in accordance with the first profile information and the second profile information; deriving the first work relevance between a first work of the first worker at a time when processing is executed and a second work of the second worker at the time in accordance with the first work plan information and the second work plan information; generating first information-to-be-presented in accordance with the first organizational distance and the first work relevance, where the first information-to-be-presented is information to be presented to the first worker as the profile of the second worker; and outputting the first information-to-be-presented.

These general or specific aspects of the present disclosure may be realized by a system, a device, a method, an integrated circuit, a computer program, a computer-readable non-transitory recording medium such as a CD-ROM, or any combination of systems, devices, methods, integrated circuits, computer programs, and recording media.

### Advantageous Effects

The information processing method and the like according to an aspect of the present disclosure enable efficiently communicating information on workers while protecting their privacy.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating an example of the configuration of an information processing system according to an embodiment.

FIG. 2 is a diagram illustrating an example of the configuration of a wearable device according to the embodiment.

FIG. 3 is a diagram illustrating exemplary display of worker information in a referential example.

FIG. 4 is a block diagram illustrating an example of the configuration of an information processing device according to the embodiment.

FIG. 5 is a block diagram illustrating a variation of the configuration of the information processing device according to the embodiment.

FIG. 6 is a block diagram illustrating an exemplary implementation of the information processing device according to the embodiment.

FIG. 7 is a diagram illustrating an example of the configuration of profile information according to the embodiment.

FIG. 8 is a diagram illustrating an example of an organizational distance according to the embodiment.

FIG. 9A is a diagram illustrating an example of construction work types according to the embodiment.

FIG. 9B is a diagram illustrating an example of construction work types according to the embodiment.

FIG. 10 is a diagram illustrating an example of the configuration of work plan information according to the embodiment.

FIG. 11 is a diagram illustrating an example of work relevance according to the embodiment.

FIG. 12 is a diagram illustrating an example of a presentation pattern according to the embodiment.

FIG. 13 is a diagram illustrating an example of the relationship among the organizational distance, the work relevance, and the presentation pattern, according to the embodiment.

FIG. 14 is a diagram illustrating exemplary display of worker information according to the embodiment.

FIG. 15 is a diagram illustrating an additional example of the presentation pattern according to the embodiment.

FIG. 16 is a diagram illustrating a variation of the relationship among the organizational distance, the work relevance, and the presentation pattern, according to the embodiment.

FIG. 17 is a flowchart illustrating exemplary operations of the information processing device according to the embodiment.

### DESCRIPTION OF EMBODIMENT

In a construction site, for example, work proceeds while various workers who do not know each other come and go according to their work plans. In such an environment with workers working together, it is not easy to efficiently communicate worker information among the workers while protecting their privacy.

In view of this, an information processing method according to Example 1 is to be performed by an information processing device and includes: obtaining first profile information indicating the profile of a first worker and second profile information indicating the profile of a second worker; obtaining first work plan information indicating the work plan of the first worker and second work plan information indicating the work plan of the second worker; deriving the first organizational distance between the first worker and the second worker in accordance with the first profile information and the second profile information; deriving the first work relevance between a first work of the first worker at a time when processing is executed and a second work of the second worker at the time in accordance with the first work plan information and the second work plan information; generating first information-to-be-presented in accordance with the first organizational distance and the first work relevance, where the first information-to-be-presented is information to be presented to the first worker as the profile of the second worker; and outputting the first information-to-be-presented.

Thus, the information-to-be-presented can be efficiently generated in accordance with the organizational distance based on the profiles, and the work relevance based on the work plans. This enables efficiently communicating worker information while protecting worker privacy.

An information processing method according to Example 2 is the information processing method according to Example 1, and in the outputting of the first information-to-be-presented, the first information-to-be-presented may be output to a wearable device of the first worker.

Thus, the secrecy of privacy can be enhanced, while efforts required for confirming worker identity can be reduced. This enables efficiently communicating worker information while protecting worker privacy.

An information processing method according to Example 3 is the information processing method according to Example 2, and the wearable device may include smart glasses for presenting the first information-to-be-presented to the first worker by an image.

Thus, the information on the second worker can be presented as an image through the smart glasses to the first worker. This enables efficiently communicating the information on the second worker to the first worker.

An information processing method according to Example 4 is the information processing method according to Example 2 or 3, and the wearable device may include a sound outputter that presents the first information-to-be-presented to the first worker by sound.

Thus, the information on the second worker can be presented as sound through the sound outputter to the first worker. This enables efficiently communicating the information on the second worker to the first worker.

An information processing method according to Example 5 is the information processing method according to any one of Examples 1 to 4, and in the deriving of the first organizational distance, the first organizational distance is derived based on: whether a first company to which the first worker belongs and a second company to which the second worker belongs are same; whether the first company and the second company belong to the same group; whether the first company and the second company belong to the same industry; and whether the first company and the second company belong to similar industries.

Thus, the organizational distance for generating the information-to-be-presented can be derived based on the relationship between the company to which the first worker belongs and the company to which the second worker belongs.

An information processing method according to Example 6 is the information processing method according to any one of Examples 1 to 5, and in the deriving of the first work relevance, the first work relevance is derived based on: whether the work space of the first work and the work space of the second work are same; whether the work object of the first work and the work object of the second work are same; and whether the work type of the first work and the work type of the second work are same.

Thus, the work relevance for generating the information-to-be-presented can be derived based on the relationships of the work space, work object, and work type of the first work with those of the second work.

An information processing method according to Example 7 is the information processing method according to any one of Examples 1 to 6, and in the generating of the first information-to-be-presented, the shorter the first organizational distance is and the higher the first work relevance is, more information may be generated as the first information-to-be-presented.

Thus, as the organizational distance is shorter and the work relevance is higher, more information-to-be-presented can be efficiently generated. This enables efficiently communicating worker information while protecting worker privacy.

An information processing method according to Example 8 is the information processing method according to any one of Examples 1 to 7. In the generating of the first information-to-be-presented, a first presentation pattern may be selected from among a plurality of presentation patterns in accordance with the first organizational distance and the first work relevance, and the first information-to-be-presented may be generated in accordance with the first presentation pattern. The plurality of presentation patterns may include: a presentation pattern including a person's name, a department name, and a company name; a presentation pattern including the family name of a person's name, a department name, and a company name; a presentation pattern including a department name and a company name; a presentation pattern including a company name; and a presentation pattern including an industry name.

Thus, a presentation pattern can be selected in accordance with the organizational distance and the work relevance from among various presentation patterns for worker profile presentation.

An information processing method according to Example 9 is the information processing method according to Example 8, and the plurality of presentation patterns may further include a presentation pattern including the family name of a person's name and a company name.

Thus, a presentation pattern can be selected in accordance with the organizational distance and the work relevance from among various presentation patterns, including a presentation pattern that includes a family name and a company name, which are useful in group work.

An information processing method according to Example 10 is the information processing method according to any one of Examples 1 to 9, and may further include: deriving the second organizational distance between the first worker and the second worker in accordance with the first profile information and the second profile information; deriving the second work relevance between the first work and the second work in accordance with the first work plan information and the second work plan information; generating second information-to-be-presented in accordance with the second organizational distance and the second work relevance, where the second information-to-be-presented is information to be presented to the second worker as the profile of the first worker; and outputting the second information-to-be-presented.

This enables efficiently communicating information on each worker to each other worker while protecting privacy.

An information processing method according to Example 11 is the information processing method according to Example 10, and in the generating of the first information-to-be-presented, a first presentation pattern may be selected from among a plurality of presentation patterns in accordance with the first organizational distance and the first work relevance, and the first information-to-be-presented may be generated in accordance with the first presentation pattern. In the generating of the second information-to-be-presented, a second presentation pattern may be selected from among the plurality of presentation patterns in accordance with the second organizational distance and the second work relevance, and the second information-to-be-presented may be generated in accordance with the second presentation pattern. When a condition is satisfied, the second presentation pattern may be different from the first presentation pattern.

This enables selecting, from among the multiple presentation patterns, the first presentation pattern for presenting the information on the second worker to the first worker and the second presentation pattern for presenting the information on the first worker to the second worker. If the condition is satisfied, different presentation patterns can be selected as the first and second presentation patterns. This enables worker information to be communicated adaptively depending on the condition.

An information processing method according to Example 12 is the information processing method according to Example 11, and the condition may be that the role of one of the first worker and the second worker in the first work and the second work is higher than the role of the other of the first worker and the second worker.

Thus, depending on the relationship between the first worker's role and the second worker's role, different presentation patterns can be selected as the first presentation pattern for presenting the information on the second worker to the first worker, and the second presentation pattern for presenting the information on the first worker to the second worker.

A program according to Example 13 may be a program for causing a computer to execute the information processing method according to any one of Examples 1 to 12.

Thus, the information processing method according to any of the above examples can be performed by a computer in accordance with the program.

An information processing device according to Example 14 may include: a profile information obtainer that obtains first profile information indicating the profile of a first worker and second profile information indicating the profile of a second worker; a work plan information obtainer that obtains first work plan information indicating the work plan of the first worker and second work plan information indicating the work plan of the second worker; an organizational distance deriver that derives the first organizational distance between the first worker and the second worker in accordance with the first profile information and the second profile information; a work relevance deriver that derives the first work relevance between a first work of the first worker at a time when processing is executed and a second work of the second worker at the time in accordance with the first work plan information and the second work plan information; a generator that generates first information-to-be-presented in accordance with the first organizational distance and the first work relevance, where the first information-to-be-presented is information to be presented to the first worker as the profile of the second worker; and an outputter that outputs the first information-to-be-presented.

Thus, the information processing device can efficiently generate the information-to-be-presented in accordance with the organizational distance based on the profiles, and the work relevance based on the work plans. Accordingly, the information processing device can efficiently communicate worker information while protecting worker privacy.

An information processing system according to Example 15 may include the information processing device according to Example 14, a wearable device that is wearable on the body of the first worker. The outputter may output the first information-to-be-presented to the wearable device, and the wearable device may present the first information-to-be-presented to the first worker.

Thus, the information processing system can efficiently generate the information-to-be-presented in accordance with the organizational distance based on the profiles, and the work relevance based on the work plans. Accordingly, the information processing system can efficiently communicate worker information while protecting worker privacy.

Moreover, these general or specific aspects of the present disclosure may be realized by a system, a device, a method, an integrated circuit, a computer program, a computer-readable non-transitory recording medium such as a CD-ROM, or any combination of systems, devices, methods, integrated circuits, computer programs, and recording media.

Hereinafter, an embodiment of the present disclosure will be described with reference to the drawings. Each of the exemplary embodiments described below shows a general or specific example of the present disclosure. The numerical values, shapes, materials, elements, the arrangement and connection of the elements, steps, an order of the steps etc. shown in the following exemplary embodiment are mere examples, and therefore do not limit the scope of the claims.

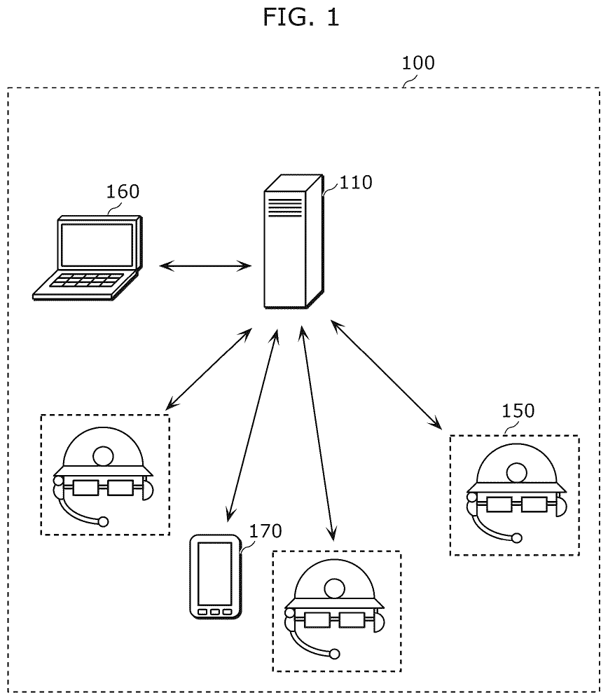

FIG. 1 is a diagram illustrating an example of the configuration of an information processing system according to an embodiment. In FIG. 1, information processing system 100 includes information processing device 110 and wearable devices 150. Information processing system 100 may further include terminal device 160 and mobile device 170. Information processing system 100 may be a system referred to as a worker communication assistance system or a communication assistance system.

Information processing device 110 is a device for processing information. Information processing device 110 may be a device referred to as a computer, a server, a worker communication assistance device, or a communication assistance device. For example, information processing device 110 collects profile information indicating a profile of each worker and distributes information-to-be-presented, which is information to be presented as the profile of each worker.

Wearable devices 150 are worn by workers. For example, each wearable device 150 obtains the information-to-be-presented from information processing device 110 and presents it as an image or sound to the worker wearing wearable device 150.

Terminal device 160 is used for inputting information. Terminal device 160 may be a device referred to as a computer or a personal computer. For example, terminal device 160 may receive input of profile information and work plan information on each worker and transmit these information items to information processing device 110.

Mobile device 170 is, as with terminal device 160, used for inputting information. Mobile device 170 may be a device referred to as a mobile terminal or a smartphone. For example, mobile device 170 of a worker may receive input of profile information and work plan information on the worker and transmit these information items to information processing device 110.

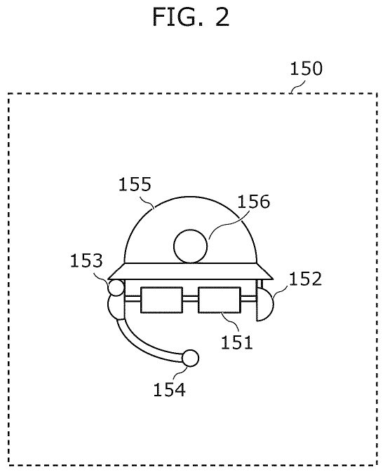

FIG. 2 is a diagram illustrating an example of the configuration of each wearable device 150 illustrated in FIG. 1. Wearable device 150 includes smart glasses 151, sound outputter 152, camera 153, microphone 154, hard hat 155, and light 156.

Smart glasses 151 are a device that is wearable like eyeglasses and displays an image on glasses to present the image to the worker wearing smart glasses 151. For example, the worker wearing smart glasses 151 can see the image superimposed on the real world. More specifically, for example, smart glasses 151 may display, as an image on the glasses, information-to-be-presented obtained from information processing device 110, thereby presenting it as an image to the worker wearing smart glasses 151.

Sound outputter 152 is a device that presents sound. Specifically, sound outputter 152 is a device that is wearable like earphones or headphones and presents sound to the worker wearing sound outputter 152. For example, sound outputter 152 may present, as sound, information-to-be-presented obtained from information processing device 110 to the worker wearing sound outputter 152.

Camera 153 is a device that obtains images of the real world. For example, an image obtained by camera 153 may be used to identify other workers. Further, an image obtained by camera 153 may be used to determine the position where information-to-be-presented obtained from information processing device 110 is to be displayed as an image.

Microphone 154 is a device that captures sound. Sound captured may be used for communication among workers. Hard hat 155 is an item that protects the head of the worker wearing hard hat 155. Light 156 is a device that illuminates the area in front of or around the worker wearing light 156.

Wearable device 150 may further include a communicator for communication with information processing device 110. The communicator may be included in any of the other components of wearable device 150.

Wearable device 150 may further include a radio frequency identification (RFID) tag and an RFID reader. The RFID tag and the RFID reader may enable identifying other workers. The RFID tag and the RFID reader may be included in any of the other components of wearable device 150.

Wearable device 150 need not include all the components illustrated in FIG. 2. For example, wearable device 150 may be smart glasses 151 or sound outputter 152.

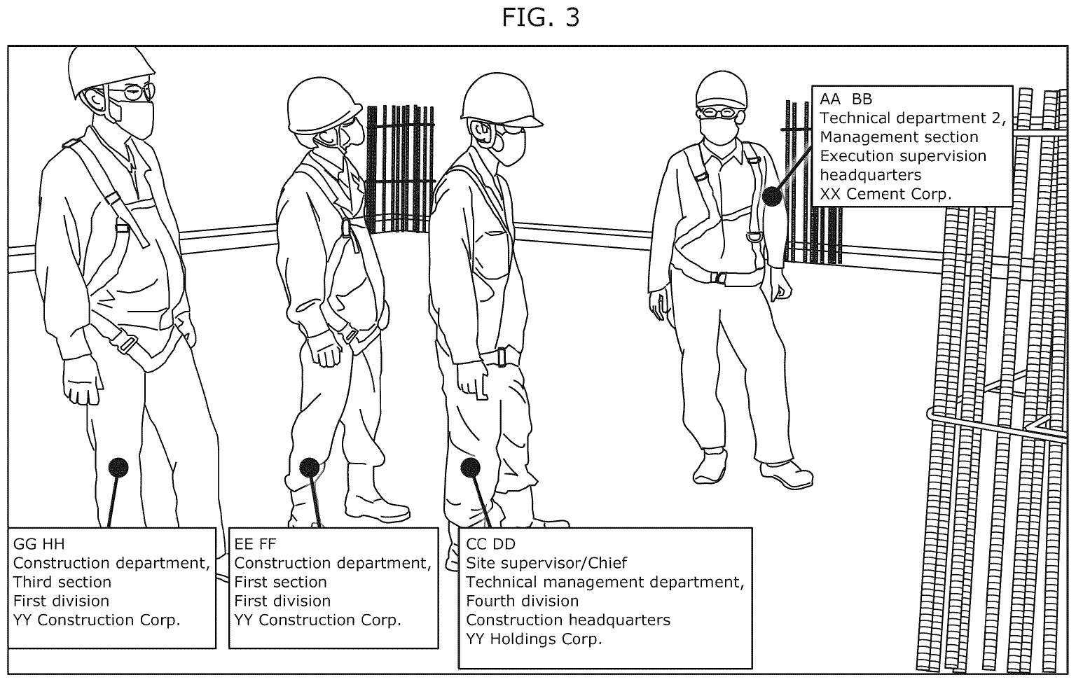

FIG. 3 is a diagram illustrating exemplary display of worker information in a referential example. For example, the exemplary display illustrated in FIG. 3 is seen through smart glasses 151. Here, four workers are seen, and information on each worker is seen as an image. In this example, the displayed information on each worker includes all of a person's name, a department name, and a company name.

Displaying the worker information will facilitate communication among the workers and also facilitate their work. On the other hand, displaying the worker information can invade their privacy. To address this, information processing device 110 in the embodiment adaptively reduces information presented as the worker information.

Note that, in FIG. 3, “XX Cement Corp.”, “YY Holdings Corp.”, and “YY Construction Corp.” each represent a company name. “AA BB”, “CC DD”, “EE FF”, and “GG HH” each represent a person's name that consists of a given name and a family name. The description between a person's name and a company name represents a department name.

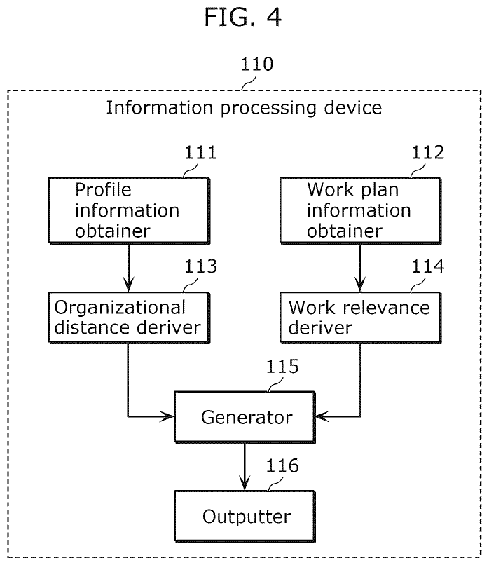

FIG. 4 is a block diagram illustrating an example of the configuration of information processing device 110 illustrated in FIG. 1. In FIG. 4, information processing device 110 includes profile information obtainer 111, work plan information obtainer 112, organizational distance deriver 113, work relevance deriver 114, generator 115, and outputter 116.

Profile information obtainer 111 is a processing circuit that obtains profile information indicating profiles of workers. For example, to present information on a second worker to a first worker, profile information obtainer 111 obtains first profile information indicating the profile of the first worker, and second profile information indicating the profile of the second worker. Profile information obtainer 111 may obtain the profile information by receiving it from outside the device or by retrieving it from, e.g., storage in information processing device 110.

Work plan information obtainer 112 is a processing circuit that obtains work plan information indicating work plans of workers. For example, to present information on the second worker to the first worker, work plan information obtainer 112 obtains first work plan information indicating the work plan of the first worker, and second work plan information indicating the work plan of the second worker. Work plan information obtainer 112 may obtain the work plan information by receiving it from outside the device or by retrieving it from, e.g., storage in information processing device 110.

Organizational distance deriver 113 is a processing circuit that derives organizational distances between workers. For example, organizational distance deriver 113 derives the organizational distance between the first worker and the second worker in accordance with the first profile information on the first worker and the second profile information on the second worker.

Work relevance deriver 114 is a processing circuit that derives work relevance between works. For example, work relevance deriver 114 derives the work relevance between a first work of the first worker at the time when processing is executed and a second work of the second worker at that time, in accordance with the first work plan information on the first worker and the second work plan information on the second worker. Here, the time when processing is executed refers to, for example, the time when information on the second worker is presented to the first worker.

Generator processing circuit that generates information-to-be-presented. For example, generator 115 generates information-to-be-presented, which is information to be presented as the profile of each worker, in accordance with the organizational distance and the work relevance.

Outputter 116 is a processing circuit that outputs the information-to-be-presented. For example, outputter 116 outputs the information-to-be-presented as information to be presented to Specifically, outputter 116 outputs the the first worker. information-to-be-presented to wearable device 150 of the first worker. That is, 116 transmits the outputter information-to-be-presented to wearable device 150 of the first worker. Wearable device 150 presents the information-to-be-presented as an image or sound to the first worker.

With the above configuration, information processing device 110 can adaptively reduce information to be presented as the worker information. Specifically, information processing device 110 can adaptively reduce, in accordance with the organizational distance and the work relevance, information to be presented as the worker information. This prevents, for example, detailed information on the second worker from being presented to the first worker who is not related much to the second worker in terms of organization and work. This enables efficiently communicating information on the second worker to the first worker while protecting the second worker's privacy.

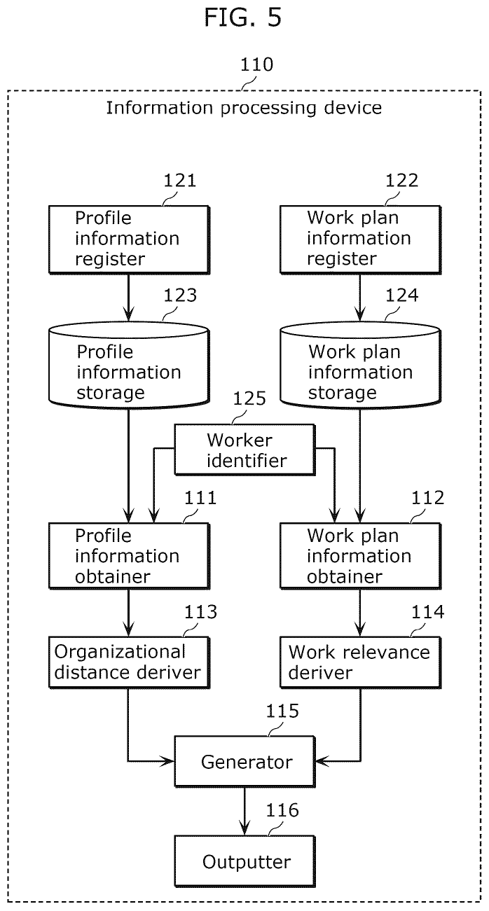

FIG. 5 is a block diagram illustrating a variation of the configuration of information processing device 110 illustrated in FIG. 4. Information processing device 110 in FIG. 5 further includes profile information register 121, work plan information register 122, profile information storage 123, work plan information storage 124, and worker identifier 125.

Profile information register 121 is a processing circuit that registers profile information on workers. For example, profile information register 121 collects profile information on each of workers by receiving it from terminal device 160, mobile device 170, or the like. Profile information register 121 then registers the collected profile information by storing it in profile information storage 123.

Work plan information register 122 is a processing circuit that registers work plan information on workers. For example, work plan information register 122 collects work plan information on each of workers by receiving it from terminal device 160, mobile device 170, or the like. Work plan information register 122 then registers the collected work plan information by storing it in work plan information storage 124.

Profile information storage 123 is a storage circuit in which profile information on workers is stored. For example, profile information storage 123 stores profile information on each of workers.

Work plan information storage 124 is a storage circuit in which work plan information on workers is stored. For example, work plan information storage 124 stores work plan information on each of workers.

Worker identifier 125 is a processing circuit that identifies workers. For example, to present information on the second worker to the first worker, worker identifier 125 identifies the first worker and the second worker. Specifically, worker identifier 125 identifies the first worker by obtaining, from the first worker's wearable device 150, identification information on the first worker wearing wearable device 150.

Worker identifier 125 may obtain an image captured by camera 153 of wearable device 150 and identify, based on the obtained image, the second worker shown in the image. Alternatively, worker identifier 125 may obtain identification information with the RFID tag and the RFID reader incorporated in each wearable device 150 and identify the second worker in accordance with the identification information.

Profile information obtainer 111 obtains, from profile information storage 123, first profile information on the first worker identified by worker identifier 125 and second profile information on the second worker identified by worker identifier 125. Work plan information obtainer 112 obtains, from work plan information storage 124, first work plan information on the first worker identified by worker identifier 125 and second work plan information on the second worker identified by worker identifier 125.

For operations other than those described above, information processing device 110 illustrated in FIG. 5 operates as in the example in FIG. 4. Thus, information processing device 110 can maintain the profile information and the work plan information on multiple workers. Information processing device 110 can output, as information to be presented to the first worker identified from among the workers, information on the second worker identified from among the workers.

Note that, in the example in FIG. 5, a device separate from information processing device 110 may include profile information register 121, work plan information register 122, profile information storage 123, work plan information storage 124, and worker identifier 125.

Alternatively, profile information register 121 and profile information storage 123 may be included in profile information obtainer 111. Work plan information register 122 and work plan information storage 124 may be included in work plan information obtainer 112. Worker identifier 125 may be included in profile information obtainer 111.

Information processing device 110 may further include a communicator for communication with wearable devices 150, terminal device 160, or mobile device 170. The communicator may be included in any of the other components of information processing device 110.

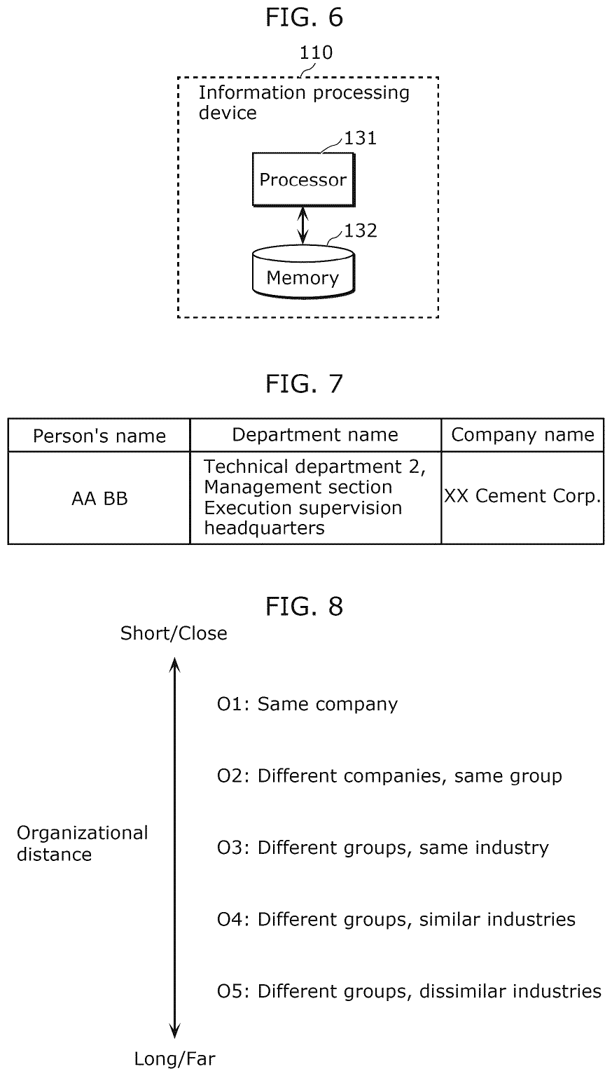

FIG. 6 is a block diagram illustrating an exemplary implementation of information processing device 110 illustrated in FIG. 1. In FIG. 6, information processing device 110 includes processor 131 and memory 132. The components of information processing device 110 illustrated in FIG. 4 or 5 may be implemented by processor 131 and memory 132 illustrated in FIG. 6.

Processor 131, which is a special-purpose or general-purpose processor used to perform information processing in the present disclosure, has access to memory 132. Processor 131 may be a processing circuit. Processor 131 may be a processor such as a CPU. Processor 131 may be an aggregation of processors.

Profile information obtainer 111, work plan information obtainer 112, organizational distance deriver 113, work relevance deriver 114, generator 115, outputter 116, profile information register 121, work plan information register 122, and worker identifier 125 illustrated in FIG. 4 or 5 may be implemented by processor 131.

Memory 132 is a special-purpose or general-purpose memory that stores information for processor 131 to perform information processing in the present disclosure. Memory 132 may be a storage circuit. Memory 132 may be connected to or included in processor 131. Memory 132 may be an aggregation of memories. Memory 132 may be a magnetic disk or an optical disc, and may be referred to as a storage or a recording medium. Memory 132 may be a nonvolatile or volatile memory.

For example, memory 132 may store the profile information, the work plan information, and the information-to-be-presented. Profile information storage 123 and work plan information storage 124 illustrated in FIG. 5 may be implemented by memory 132. Memory 132 may store a program for processor 131 to perform information processing in the present disclosure.

FIG. 7 is a diagram illustrating an example of the configuration of the profile information according to the embodiment. The profile information as illustrated in FIG. 7 is set for each worker. Here, the profile of a worker includes information such as introduction and attributes of the worker. The organizational distance is derived in accordance with the profile information. In FIG. 7, the profile information includes a person's name, a department name, and a company name.

Note that the profile information may include any information, including information different from that illustrated in the example in FIG. 7. For example, the profile information may further include the industry of the company. The profile information may further include the group name of the company. The profile information may further include information indicating related companies and their relationships with the company.

FIG. 8 is a diagram illustrating an example of the organizational distance according to the embodiment. FIG. 8 shows five organizational distances O1 to O5.

Specifically, in this example, the organizational distance between the first worker and the second worker is the shortest if the company to which the first worker belongs and the company to which the second worker belongs is the same (O1). If the company to which the first worker belongs and the company to which the second worker belongs are in the same group, the organizational distance between the first worker and the second worker is the second shortest (O2). If the company to which the first worker belongs and the company to which the second worker belongs are in the same industry, the organizational distance between the first worker and the second worker is the third shortest (O3).

If the company to which the first worker belongs and the company to which the second worker belongs are in industries similar to each other, the organizational distance between the first worker and the second worker is the fourth shortest (O4). If the company to which the first worker belongs and the company to which the second worker belongs are in industries dissimilar from each other, the organizational distance between the first worker and the second worker is the longest (O5).

Information indicating group companies may be included in the profile information. Alternatively, information indicating group companies of each company may be stored in, e.g., profile information storage 123. Based on the group company information, group companies of each worker's company may be derived.

Information indicating the industry of the company may be included in the profile information. Alternatively, information indicating the industry of each company may be stored in, e.g., profile information storage 123. Based on the industry information, the industry of each worker's company may be derived.

Information indicating industries similar to the industry of the company may be included in the profile information. Alternatively, information indicating industries similar to the industry of each company may be stored in, e.g., profile information storage 123. Based on the similar industry information, industries similar to the industry of each worker's company may be derived.

The organizational distance may be determined in any manner, such as a manner different from that illustrated in FIG. 8.

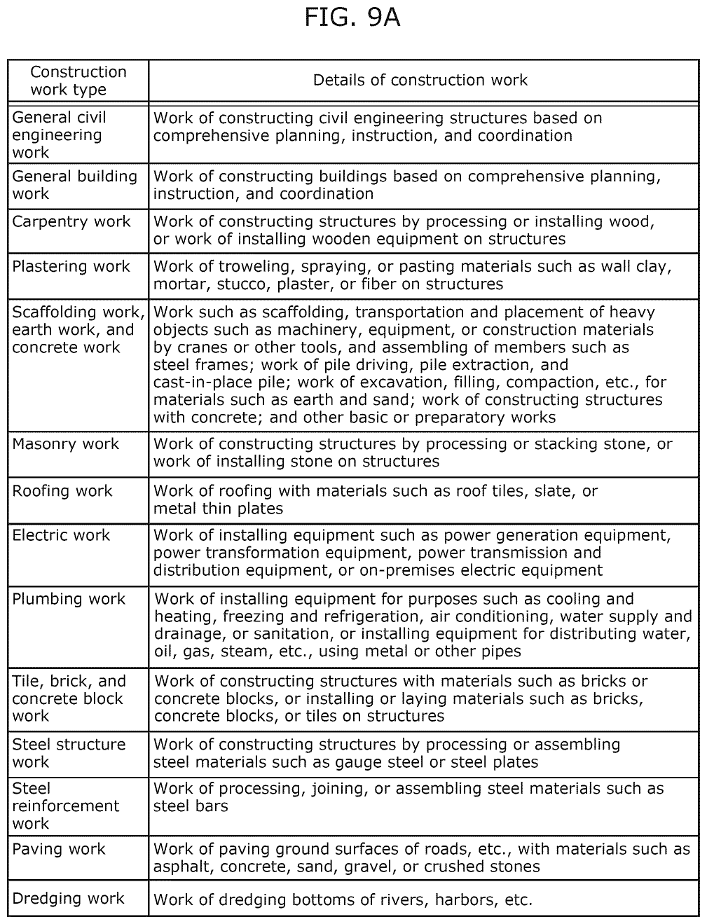

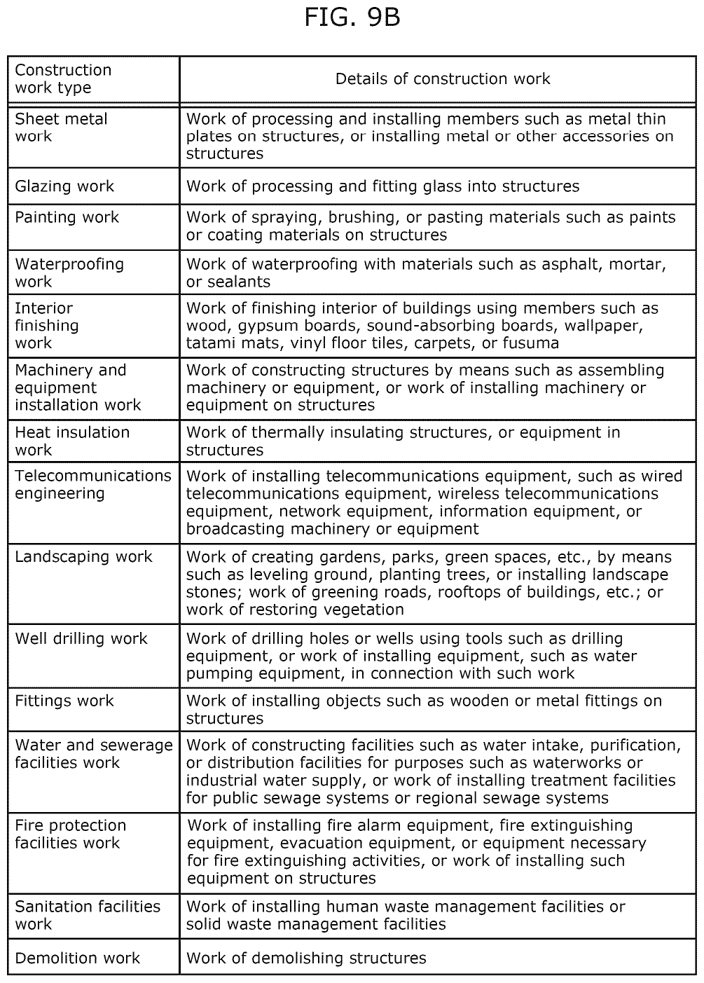

FIGS. 9A and 9B are diagrams illustrating examples of construction work types according to the embodiment. For example, the construction work types correspond to industries. Note that the construction work types illustrated here are mere examples of industries, and other types may be defined as industries.

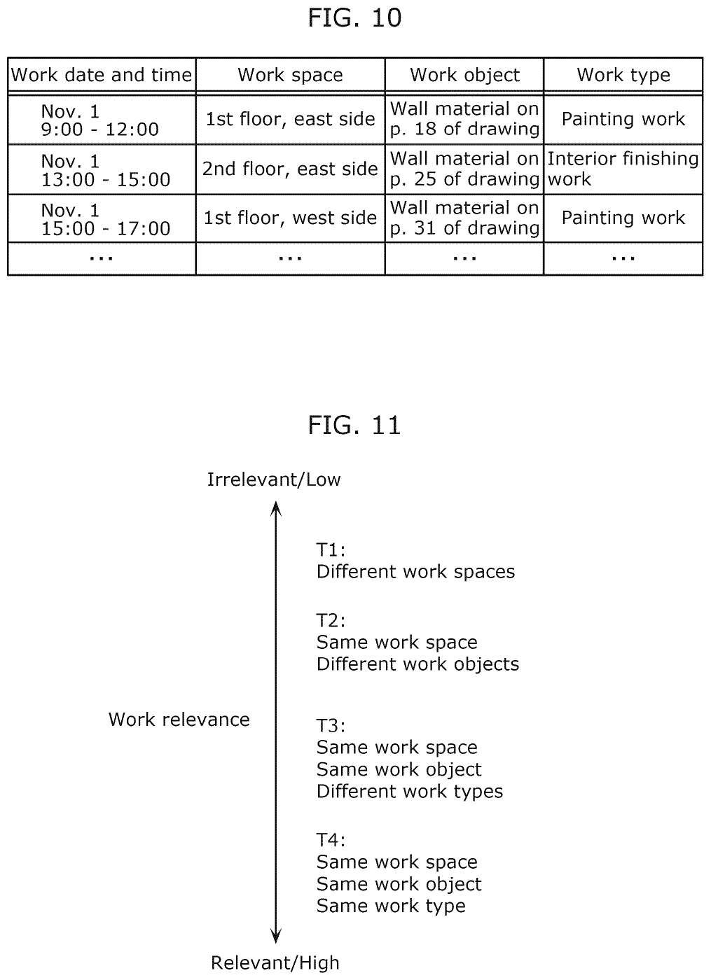

FIG. 10 is a diagram illustrating an example of the configuration of the work plan information according to the embodiment. The work plan information as illustrated in FIG. 10 is set for each worker. The work relevance is derived in accordance with the work plan information. In FIG. 10, the work plan information includes the work date and time, the work space, the work object, and the work type of the worker.

For example, the work date and time indicates the date and time when each work process is to be performed. The work object indicates a building material or facility for which the work process is to be performed. The work type indicates the details of work for the work object. Specifically, the construction work types illustrated in FIGS. 9A and FIG. 9B correspond to work types. Note that the construction work types illustrated in FIGS. 9A and 9B are mere examples of work types, and other types may be defined as work types.

Note that the work plan information may include any information, including information different from that illustrated in the example in FIG. 10.

FIG. 11 is a diagram illustrating an example of the work relevance according to the embodiment. FIG. 11 shows four levels of work relevance T1 to T4. Specifically, in this example, the work relevance between first work and second work is the lowest if the work space of the first work is different from the work space of the second work (T1). If the work space of the first work is the same as the work space of the second work and the work object of the first work is different from the work object of the second work, the work relevance between the first work and the second work is the second lowest (T2).

If the work space of the first work is the same as the work space of the second work, the work object of the first work is the same as the work object of the second work, and the work type of the first work is different from the work type of the second work, the work relevance between the first work and the second work is the third lowest (T3). If the work space of the first work is the same as the work space of the second work, the work object of the first work is the same as the work object of the second work, and the work type of the first work is the same as the work type of the second work, the work relevance between the first work and the second work is the highest (T4).

Note that the work relevance may be determined in any manner, such as a manner different from that illustrated in FIG. 11.

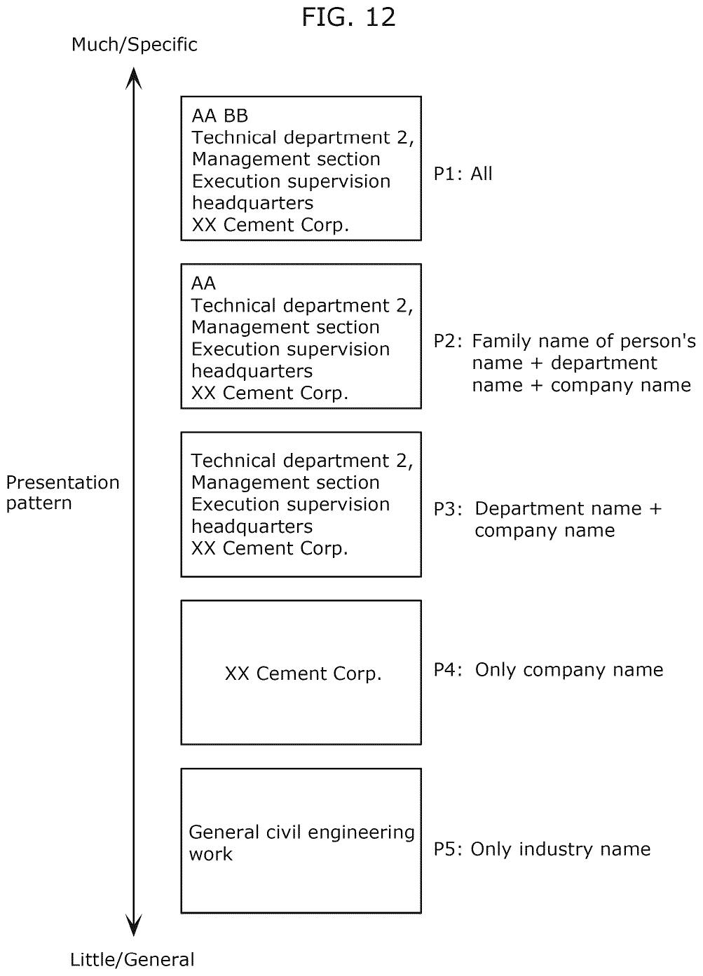

FIG. 12 is a diagram illustrating an example of the presentation pattern according to the embodiment. FIG. 12 shows presentation patterns P1 to P5. P1 allows display of all of a person's name, a department name, and a company name. P2 allows display of the family name of a person's name, a department name, and a company name. P3 allows display of a department name and a company name. P4 allows display of only a company name. P5 allows display of only an industry name.

One of these presentation patterns is selected in accordance with the organizational distance and the work relevance. Using the presentation pattern selected, the information-to-be-presented is generated.

Note that the presentation patterns may be set in any manner, such as a manner different from that illustrated in the example in FIG. 12.

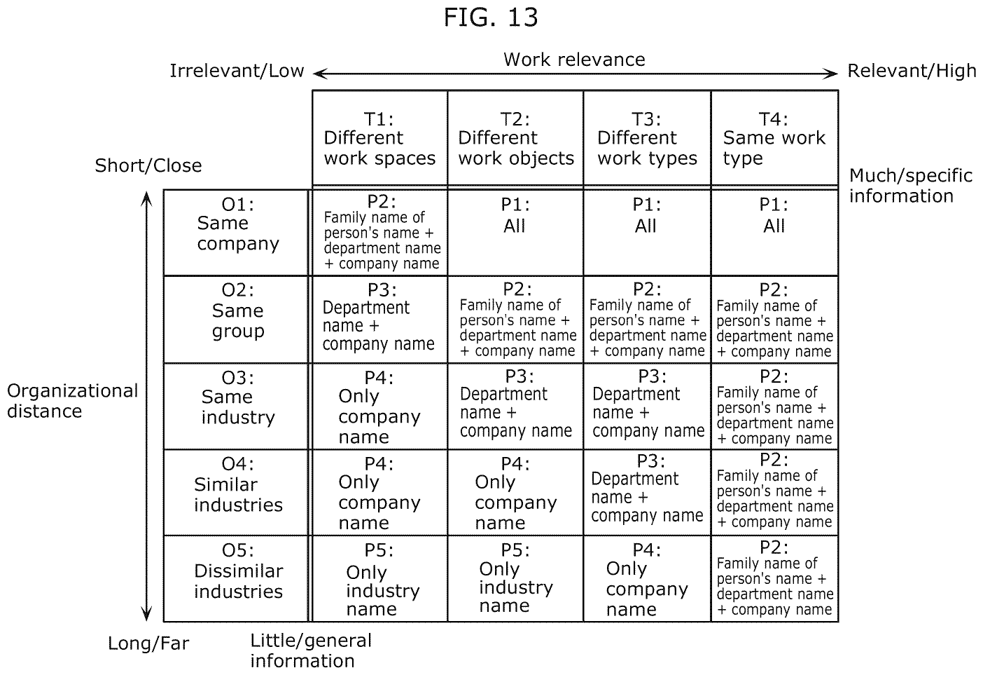

FIG. 13 is a diagram illustrating an example of the relationship among the organizational distance, the work relevance, and the presentation pattern, according to the embodiment. The presentation pattern is selected in accordance with the organizational distance and the work relevance. As the organizational distance is shorter and the work relevance is higher, a presentation pattern providing more information is selected. Conversely, as the organizational distance is longer and the work relevance is lower, a presentation pattern providing less information is selected.

Note that the relationship among the organizational distance, the work relevance, and the presentation pattern may be set in any manner, such as a manner different from that illustrated in the example in FIG. 13.

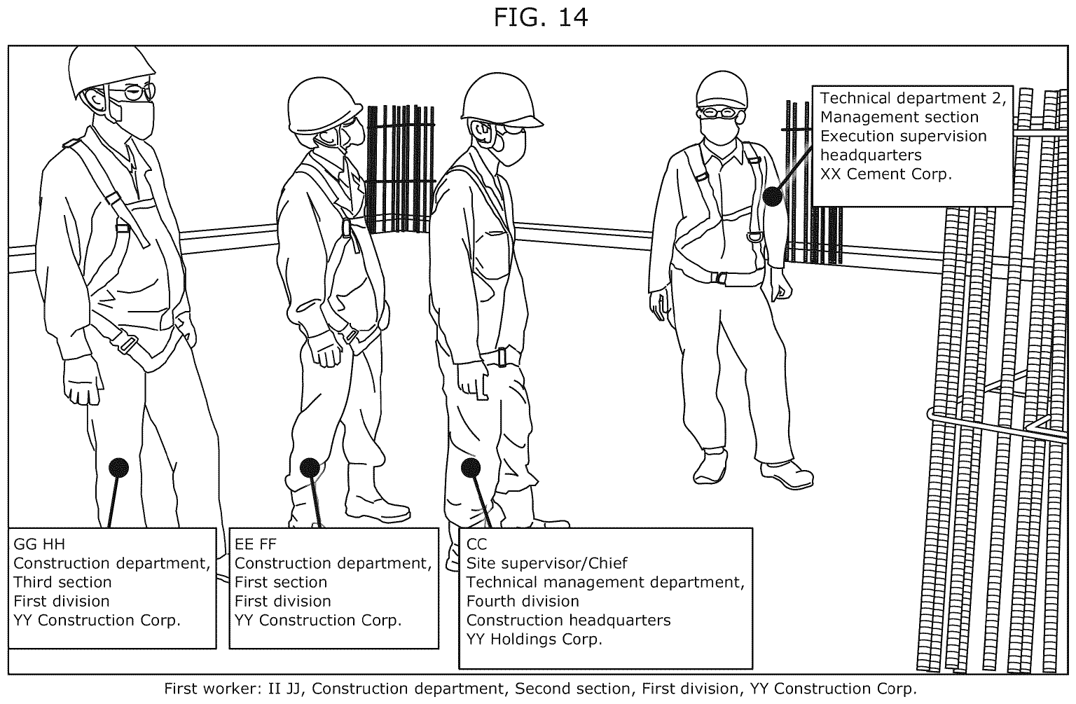

FIG. 14 is a diagram illustrating exemplary display of worker information according to the embodiment. This example illustrates display of information presented to the first worker. The first worker's person's name, department name, and company name are “II JJ”, “Construction department, Second section, First division”, and “YY Construction Corp.”, respectively.

In this example, the organizational distance between the first worker and the rightmost worker is “O4: different groups, similar industries”. The organizational distance between the first worker and the worker second from right is “O2: different companies, the same group”. The organizational distance between the first worker and the worker third from right is “O1: the same company”. The organizational distance between the first worker and the leftmost worker is also “O1: the same company.”

The example here assumes that the work relevance between the work of the first worker and the work of each of the four workers shown in the exemplary display is “T3: the same work space, the same work object, different work types”.

In this case, applying the relationship in FIG. 13 yields the display as illustrated in FIG. 14. Specifically, the presentation pattern for the rightmost worker is “P3: “department name+company name”. The presentation pattern for the worker second from right is “P2: family name of person's name+department name+company name”. The presentation pattern for the worker third from right is “P1: all”. The presentation pattern for the leftmost worker is also “P1: all”.

Thus, the information presented as the worker information is adaptively reduced in accordance with the organizational distance and the work relevance. This can protect privacy in the display provided for smooth communication.

The four workers in the exemplary display in FIG. 14 may be referred to as, for example, second, third, fourth, and fifth workers, respectively. Information on such multiple workers may simultaneously be presented to the first worker in accordance with the organizational distance between the first worker and each of the multiple workers, and the work relevance between the work of the first worker and the work of each of the multiple workers.

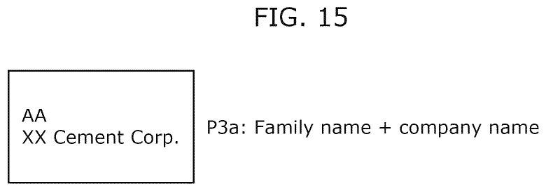

FIG. 15 is a diagram illustrating an additional example of the presentation pattern according to the embodiment. In communication during group work, the person's name may be useful rather than the department name. Therefore, a family name in combination with information on a company name may be used as additional presentation pattern P3a. This presentation pattern is useful especially in communication among workers belonging to different companies or different groups.

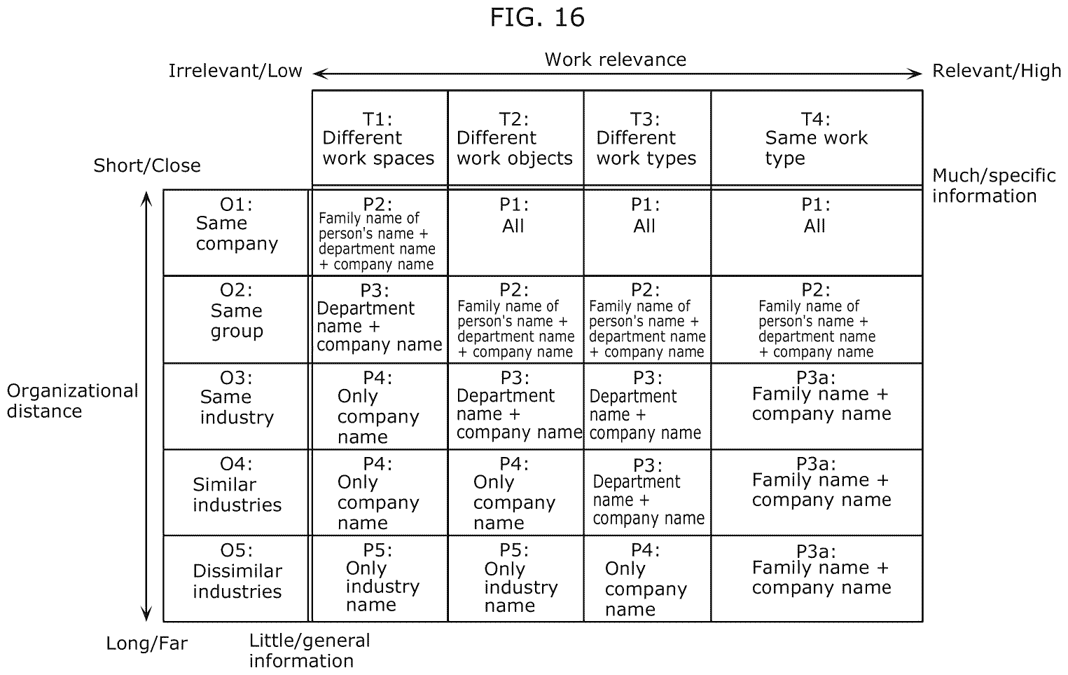

FIG. 16 is a diagram illustrating a variation of the relationship among the organizational distance, the work relevance, and the presentation pattern, according to the embodiment. Here, if the organizational distance is any of O3 (same industry), O4 (similar industries), and O5 (dissimilar industries) and the work relevance is T4 (same work type), then presentation pattern P3a (family name+company name) illustrated in FIG. 15 is used. This may enable efficiently communicating worker information while protecting privacy.

In an example, when information on the second worker is presented to the first worker, information on the first worker is similarly presented to the second worker. That is, the information on the first worker is presented to the second worker in the same pattern as the information on the second worker presented to the first worker.

However, the information on the first worker may be presented to the second worker in a pattern different from the pattern of the information on the second worker presented to the first worker. For example, if the first worker plays a role higher than the role of the second worker in their work, the presentation pattern of the information on the second worker presented to the first worker may include more information than the presentation pattern of the information on the first worker presented to the second worker.

Whether the first worker plays a role higher than the role of the second worker may be determined in accordance with the profile information and the work plan information. Specifically, whether the first worker plays a role higher than the role of the second worker may be determined in accordance with part or all of the first worker's organization and work and the second worker's organization and work. For example, the profile information may include information indicating higher-level organizations or lower-level organizations, and the work plan information may include information indicating higher-level work or lower-level work.

In an example, as to the organizational distance between the first worker and the second worker, a first organizational distance for generating first information-to-be-presented to be presented to the first worker may be different from a second organizational distance for generating second information-to-be-presented to be presented to the second worker.

Specifically, if one of the first worker's company and the second worker's company is under the umbrella of the other, the first organizational distance may be different from the second organizational distance. More specifically, if the second worker's company is under the umbrella of the first worker's company, the first organizational distance may be regarded as O1 (the same company) and the second organizational distance may be regarded as O2 (the same group).

Similarly, as to the work relevance between the first worker's work and the second worker's work, first work relevance for generating the first information-to-be-presented to be presented to the first worker may be different from second work relevance for generating the second information-to-be-presented to be presented to the second worker.

Specifically, if one of the first worker's work and the second worker's work includes the other, the first work relevance may be different from the second work relevance. More specifically, if the first worker's work includes the second worker's work, the first work relevance may be regarded as T4 (the same work type) and the second work relevance may be regarded as T3 (different work types).

Thus, information on the first worker and information on the second worker can be exchanged more flexibly in accordance with the relationship between the first worker's role and the second worker's role in their work.

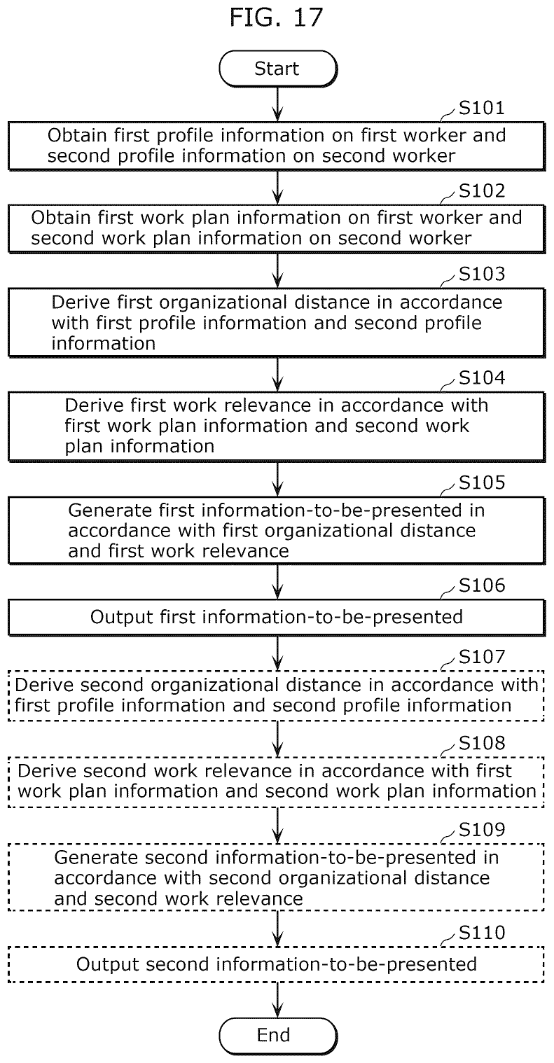

FIG. 17 is a flowchart illustrating exemplary operations of information processing device 110 illustrated in FIG. 4 and other diagrams. Profile information obtainer 111 in information processing device 110 obtains first profile information indicating a profile of a first worker, and second profile information indicating a profile of a second worker (S101). Work plan information obtainer 112 in information processing device 110 obtains first work plan information indicating a work plan of the first worker, and second work plan information indicating a work plan of the second worker (S102).

Organizational distance deriver 113 in information processing device 110 derives a first organizational distance between the first worker and the second worker in accordance with the first profile information and the second profile information (S103). Work relevance deriver 114 in information processing device 110 derives a first work relevance between a first work of the first worker at the time when processing is executed and a second work of the second worker at that time, in accordance with the first work plan information and the second work plan information (S104).

Generator 115 in information processing device 110 generates first information-to-be-presented in accordance with the first organizational distance and the first work relevance, the first information-to-be-presented being information to be presented to the first worker as the profile of the second worker (S105). Outputter 116 in information processing device 110 outputs the first information-to-be-presented (S106).

Thus, information processing device 110 can efficiently generate the information-to-be-presented in accordance with the organizational distance based on the profiles, and the work relevance based on the work plans. Accordingly, information processing device 110 can efficiently communicate worker information while protecting worker privacy.

Further, organizational distance deriver 113 may derive a second organizational distance between the first worker and the second worker in accordance with the first profile information and the second profile information (S107). Work relevance deriver 114 may derive a second work relevance between the first work and the second work in accordance with the first work plan information and the second work plan information (S108).

Generator 115 may generate second information-to-be-presented in accordance with the second organizational distance and the second work relevance, the second information-to-be-presented being information to be presented to the second worker as the profile of the first worker (S109). Outputter 116 may output the second information-to-be-presented (S110).

Thus, information processing device 110 can efficiently communicate information on each worker to each other worker while protecting privacy.

In an example, outputter 116 may output the first information-to-be-presented to wearable device 150 of the first worker. Outputter 116 may also output the second information-to-be-presented to wearable device 150 of the second worker.

Thus, information processing device 110 can enhance the secrecy of privacy while reducing efforts required for confirming worker identity. Accordingly, information processing device 110 can efficiently communicate worker information while protecting worker privacy.

In an example, wearable device 150 of the first worker may include smart glasses 151 that present the first information-to-be-presented as an image to the first worker. Thus, information processing device 110 can present the information on the second worker as an image to the first worker through smart glasses 151 included in wearable device 150 of the first worker. Accordingly, information processing device 110 can efficiently communicate the information on the second worker to the first worker.

Similarly, wearable device 150 of the second worker may include smart glasses 151 that present the second information-to-be-presented as an image to the second worker. Thus, information processing device 110 can present the information on the first worker as an image to the second worker through smart glasses 151 included in wearable device 150 of the second worker. Accordingly, information processing device 110 can efficiently communicate the information on the first worker to the second worker.

In an example, wearable device 150 of the first worker may include sound 152 presents outputter that the first information-to-be-presented as sound to the first worker. Thus, information processing device 110 can present the information on the second worker as sound to the first worker through sound outputter 152 included in wearable device 150 of the first worker. Accordingly, information processing device 110 can efficiently communicate the information on the second worker to the first worker.

Similarly, wearable device 150 of the second worker may include sound outputter 152 that presents the second information-to-be-presented as sound to the second worker. Thus, information processing device 110 can present the information on the first worker as sound to the second worker through sound outputter 152 included in wearable device 150 of the second worker. Accordingly, information processing device 110 can efficiently communicate the information on the first worker to the second worker.

In an example, organizational distance deriver 113 may derive the first organizational distance based on: whether a first company to which the first worker belongs and a second company to which the second worker belongs are the same; whether the first company and the second company belong to the same group; whether the first company and the second company belong to the same industry; and whether the first company and the second company belong to similar industries. Similarly, organizational distance deriver 113 may derive the second organizational distance based on: whether the first company to which the first worker belongs and the second company to which the second worker belongs are the same; whether the first company and the second company belong to the same group; whether the first company and the second company belong to the same industry; and whether the first company and the second company belong to similar industries.

Thus, information processing device 110 can derive, based on the relationship between the company to which the first worker belongs and the company to which the second worker belongs, the organizational distance for generating the information-to-be-presented.

In an example, work relevance deriver 114 may derive the first work relevance based on: whether a work space of the first work and a work space of the second work are the same; whether a work object of the first work and a work object of the second work are the same; and whether a work type of the first work and a work type of the second work are the same. Similarly, work relevance deriver 114 may derive the second work relevance based on: whether the work space of the first work and the work space of the second work are the same; whether the work object of the first work and the work object of the second work are the same; and whether the work type of the first work and the work type of the second work are the same.

Thus, information processing device 110 can derive, based on the relationships of the work space, work object, and work type of the first work with those of the second work, the work relevance for generating the information-to-be-presented.

In an example, the shorter the first organizational distance is and the higher the first work relevance is, more information generator 115 may generate as the first information-to-be-presented. Similarly, the shorter the second organizational distance is and the higher the second work relevance is, more information generator 115 may generate as the second information-to-be-presented.

Thus, as the organizational distance is shorter and the work relevance is higher, information processing device 110 can efficiently generate more information-to-be-presented. Accordingly, information processing device 110 can efficiently communicate worker information while protecting worker privacy.

In an example, generator 115 may select a first presentation pattern from among multiple presentation patterns in accordance with the first organizational distance and the first work relevance. Generator 115 then generate the first may information-to-be-presented in accordance with the first presentation pattern.

Here, the multiple presentation patterns may include a presentation pattern including a person's name, a department name, and a company name. The multiple presentation patterns may include a presentation pattern including the family name of a person's name, a department name, and a company name. The multiple presentation patterns may include a presentation pattern including a department name and a company name. The multiple presentation patterns may include a presentation pattern including a company name. The multiple presentation patterns may include a presentation pattern including an industry name.

Thus, information processing device 110 can select a presentation pattern in accordance with the organizational distance and the work relevance from among various presentation patterns for worker profile presentation.

In an example, the multiple presentation patterns may further include a presentation pattern including the family name of a person's name and a company name.

Thus, information processing device 110 can select a presentation pattern in accordance with the organizational distance and the work relevance from among various presentation patterns, including a presentation pattern that includes a family name and a company name, which are useful in group work.

In an example, generator 115 may select a first presentation pattern from among multiple presentation patterns in accordance with the first organizational distance and the first work relevance. Generator 115 may then generate the first information-to-be-presented in accordance with the first presentation pattern. Similarly, generator 115 may select a second presentation pattern from among the multiple presentation patterns in accordance with the second organizational distance and the second work relevance. Generator 115 may then generate the second information-to-be-presented in accordance with the second presentation pattern. Here, when a condition is satisfied, the second presentation pattern may be different from the first presentation pattern.

Thus, information processing device 110 can select, from among the multiple presentation patterns, the first presentation pattern for presenting the information on the second worker to the first worker and the second presentation pattern for presenting the information on the first worker to the second worker. If the condition is satisfied, information processing device 110 may select different presentation patterns as the first and second presentation patterns. Accordingly, information processing device 110 can communicate worker information adaptively depending on the condition.

In an example, the condition may be that a role of one of the first worker and the second worker in the first work and the second work is higher than a role of the other of the first worker and the second worker.

Thus, depending on the relationship between the first worker's role and the second worker's role, information processing device 110 can select different presentation patterns for the first presentation pattern for presenting the information on the second worker to the first worker, and the second presentation pattern for presenting the information on the first worker to the second worker.

The above processing may only include processing related to the operations for presenting the information on the second worker to the first worker, and may exclude processing related to the operations for presenting the information on the first worker to the second worker.

The information presentation is not limited to presentation between two workers: the first worker and the second worker. Rather, information may be presented among three workers from first to third workers, or even more workers.

Specifically, information on workers including the second and third workers may simultaneously be presented to the first worker. Similarly, information on workers including the first and third workers may simultaneously be presented to the second worker. Similarly, information on workers including the first and second workers may simultaneously be presented to the third worker.

In other words, in the above description, each of the two or more workers may be the second worker. Each of the two or more workers may be the first worker.

While aspects of the information processing system and the information processing device have been described above according to the embodiment, aspects of the information processing system and the information processing device are not limited to the above embodiment. Modifications that may occur to those skilled in the art may be made to the embodiment, and elements of the embodiment may be combined as appropriate.

For example, processing performed by a specific component in the embodiment may be performed by another component instead. The order of process steps may be changed, and multiple process steps may be performed in parallel. The ordinal numbers, such as first and second, used in the description may be replaced, eliminated, or newly assigned as appropriate. The ordinal numbers do not necessarily correspond to a meaningful order and may be used for discrimination among elements.

Although the above description is focused on assisting communication among workers in a construction site, the scope of application of the information processing system and the information processing device in the present disclosure is not limited to construction sites. The information processing system and the information processing device in the present disclosure are useful for assisting communication among various workers who perform various sorts of work.

An information processing method that includes the steps performed by the components of the information processing system and the information processing device may be performed by any system or device. That is, the information processing method may be performed by the above-described information processing system or information processing device, or by other systems or devices.

For example, part or all of the information processing method may be performed by a computer that includes components such as a processor, a memory, and an input/output circuit. In this case, the information processing method may be performed by the computer executing a program for causing the computer to perform the information processing method.

For example, the program causes the computer to execute an information processing method that includes: obtaining first profile information indicating the profile of a first worker and second profile information indicating the profile of a second worker; obtaining first work plan information indicating the work plan of the first worker and second work plan information indicating the work plan of the second worker; deriving the first organizational distance between the first worker and the second worker in accordance with the first profile information and the second profile information; deriving the first work relevance between a first work of the first worker at a time when processing is executed and a second work of the second worker at the time in accordance with the first work plan information and the second work plan information; generating first information-to-be-presented in accordance with the first organizational distance and the first work relevance, where the first information-to-be-presented is information to be presented to the first worker as the profile of the second worker; and outputting the first information-to-be-presented.

The program may be recorded on a non-transitory computer-readable recording medium such as a CD-ROM.

Moreover, constituent elements of the information processing system and the information processing device may be configured by dedicated hardware, general hardware that executes the program, or a combination thereof. The general hardware may be configured by memory on which the program is recorded and a general processor reading out and executing the program from the memory. The memory may be semiconductor memory, a hard disk, or the like, and the general processor may be a CPU or the like.

The dedicated hardware may be configured by memory, a dedicated processor, and the like. For example, the dedicated processor may reference the memory and execute the information processing method described above.

Each constituent element of the information processing system or the information processing device may be an electrical circuit. These electrical circuits may be included in a single electrical circuit as a whole or may be separate circuits. Moreover, these electrical circuits may correspond to dedicated hardware or general hardware that executes the program or the like.

### INDUSTRIAL APPLICABILITY

The present disclosure is effective for information processing methods for communicating information on workers while protecting their privacy, and is applicable to systems and the like for assisting communication at sites such as construction sites.

1. An information processing method to be performed by an information processing device, the information processing method comprising:
obtaining first profile information indicating a profile of a first worker and second profile information indicating a profile of a second worker;
obtaining first work plan information indicating a work plan of the first worker and second work plan information indicating a work plan of the second worker;
deriving a first organizational distance between the first worker and the second worker in accordance with the first profile information and the second profile information;
deriving a first work relevance between a first work of the first worker at a time when processing is executed and a second work of the second worker at the time in accordance with the first work plan information and the second work plan information;
generating first information-to-be-presented in accordance with the first organizational distance and the first work relevance, the first information-to-be-presented being information to be presented to the first worker as the profile of the second worker; and
outputting the first information-to-be-presented.

2. The information processing method according to claim 1, wherein
in the outputting of the first information-to-be-presented, the first information-to-be-presented is output to a wearable device of the first worker.

3. The information processing method according to claim 2, wherein
the wearable device includes smart glasses for presenting the first information-to-be-presented to the first worker by an image.

4. The information processing method according to claim 2, wherein
the wearable device includes a sound outputter that presents the first information-to-be-presented to the first worker by sound.

5. The information processing method according to claim 1, wherein
in the deriving of the first organizational distance, the first organizational distance is derived based on: whether a first company to which the first worker belongs and a second company to which the second worker belongs are same; whether the first company and the second company belong to a same group; whether the first company and the second company belong to a same industry; and whether the first company and the second company belong to similar industries.

6. The information processing method according to claim 1, wherein
in the deriving of the first work relevance, the first work relevance is derived based on: whether a work space of the first work and a work space of the second work are same; whether a work object of the first work and a work object of the second work are same; and whether a work type of the first work and a work type of the second work are same.

7. The information processing method according to claim 1, wherein
in the generating of the first information-to-be-presented, the shorter the first organizational distance is and the higher the first work relevance is, more information is generated as the first information-to-be-presented.

8. The information processing method according to claim 1, wherein
in the generating of the first information-to-be-presented, a first presentation pattern is selected from among a plurality of presentation patterns in accordance with the first organizational distance and the first work relevance, and the first information-to-be-presented is generated in accordance with the first presentation pattern, and
the plurality of presentation patterns include: a presentation pattern including a person's name, a department name, and a company name; a presentation pattern including a family name of a person's name, a department name, and a company name; a presentation pattern including a department name and a company name; a presentation pattern including a company name; and a presentation pattern including an industry name.

9. The information processing method according to claim 8, wherein
the plurality of presentation patterns include a presentation pattern including a family name of a person's name and a company name.

10. The information processing method according to claim 1, further comprising:
deriving a second organizational distance between the first worker and the second worker in accordance with the first profile information and the second profile information;
deriving a second work relevance between the first work and the second work in accordance with the first work plan information and the second work plan information;
generating second information-to-be-presented in accordance with the second organizational distance and the second work relevance, the second information-to-be-presented being information to be presented to the second worker as the profile of the first worker; and
outputting the second information-to-be-presented.

11. The information processing method according to claim 10, wherein
in the generating of the first information-to-be-presented, a first presentation pattern is selected from among a plurality of presentation patterns in accordance with the first organizational distance and the first work relevance, and the first information-to-be-presented is generated in accordance with the first presentation pattern,
in the generating of the second information-to-be-presented, a second presentation pattern is selected from among the plurality of presentation patterns in accordance with the second organizational distance and the second work relevance, and the second information-to-be-presented is generated in accordance with the second presentation pattern, and
when a condition is satisfied, the second presentation pattern is different from the first presentation pattern.

12. The information processing method according to claim 11, wherein
the condition is that a role of one of the first worker and the second worker in the first work and the second work is higher than a role of an other of the first worker and the second worker.

13. A non-transitory computer-readable recording medium having recorded thereon a computer program for causing a computer to execute the information processing method according to claim 1.

14. An information processing device comprising:
a profile information obtainer that obtains first profile information indicating a profile of a first worker and second profile information indicating a profile of a second worker;
a work plan information obtainer that obtains first work plan information indicating a work plan of the first worker and second work plan information indicating a work plan of the second worker;
an organizational distance deriver that derives a first organizational distance between the first worker and the second worker in accordance with the first profile information and the second profile information;
a work relevance deriver that derives a first work relevance between a first work of the first worker at a time when processing is executed and a second work of the second worker at the time in accordance with the first work plan information and the second work plan information;
a generator that generates first information-to-be-presented in accordance with the first organizational distance and the first work relevance, the first information-to-be-presented being information to be presented to the first worker as the profile of the second worker; and
an outputter that outputs the first information-to-be-presented.

15. An information processing system comprising:
the information processing device according to claim 14;
a wearable device that is wearable on a body of the first worker, wherein
the outputter outputs the first information-to-be-presented to the wearable device, and
the wearable device presents the first information-to-be-presented to the first worker.
